(19) United States
(12) Patent Application Publication
(10) Pub. No.: US 2024/0052622 A1
(43) Pub. Date: Feb. 15, 2024

(54) MANHOLE ODOR TREATMENT DEVICE

(71) Applicant: Heyward Florida Incorporated, Winter Park, FL (US)

(72) Inventor: Kevin M. Vickers, Winter Park, FL (US)

(21) Appl. No.: 17/818,510

(22) Filed: Aug. 9, 2022

(51) Int. Cl. E03F 5/10; E03F 5/08; E02D 29/14

(52) U.S. Cl. CPC E03F 5/105; E03F 5/08; E02D 29/149

(57) ABSTRACT

An odor treatment device for a sewer that installs beneath a manhole cover. The device is formed from a circular shaped housing that fits within a manhole opening without modification. The housing is defined by sidewalls constructed and arranged to direct air an admixture of essential oils and a surfactant for treating of sewer odors. A baffle arrangement increases the velocity of air passing the admixture.

### FIELD OF THE INVENTION

The field of the invention is wastewater treatment, namely, an odor treatment device for manhole placement.

### BACKGROUND OF THE INVENTION

Wastewater from homes and businesses flow through sewer lines, which is part of the infrastructure employed by municipalities to transfer wastewater. Conventionally, lateral sewer pipes carry wastewater from the home or business to a sewer line located in an easement, such as beneath a street surface. Ideally, the sewage flows with the use of gravity through sewer lines having progressively larger pipes until it reaches a wastewater treatment plant. Throughout the gravity system, manholes are installed in conjunction with pipe to allow for access, inspection, connection, and maintenance. In a conventional gravity system, transfer of wastewater is from a higher elevation to a lower elevation, wherein gravity allows further wastewater fluid flow.

The main elements of a manhole are the bottom section, barrel section, cone section, riser, ring and cover. The manhole receives waste from one or more sources, where it is conveyed to a single discharge pipe. The incoming flow to the manhole can come into the structure at the bottom or barrel section. When the flows enter the manhole area, there can be turbulences that result in the release of volatile compounds contained in the wastewater. During conveyance, the wastewater contains certain bacteria that grow and convert waste constituents into new compounds, resulting in odors that can be quantified as slight to outright annoying. These odors can also contain compounds that are hazardous. In some instances, these odors escape from the manhole through the manhole ring and cover as the sewer system conveys flows throughout the day. As the water level rises in the sewer system, air releases from the system carrying with it, odors. This action, along with the propensity of odors to diffuse from areas of higher concentration to lower concentration, causes odors to be released from the sewer system.

U.S. Pat. No. 10,619,341 entitled “Wastewater Lift Station Vent Odor Neutralization Device” which discloses an odor treatment device for use in lift stations having similar odor issues as do manhole areas.

The odor emanating from manhole areas is commonly treated by the use of activated carbon devices, which are known to adsorb unpleasant odors and gases using activated carbon material. The activated carbon material consists of a specially treated charcoal that has been oxygenated at a high pressure to create hundreds of thousands of pores on the surface of the material. In this manner, the activated carbon acts like a sponge to adsorb peculiar gases and odors. The longevity of the activated carbon is dependent upon the pores that are being filled with the objectionable matter. Once filled, the activated carbon can either be disposed of, or re-fired for additional activation.

Air scrubbers are known in the industry for removing odors using a liquid to wash unwanted pollutants from a gas stream. However, such devices are costly, require excessive maintenance, and are impractical for treating odors released from manholes.

What is needed in the industry is a passive venting device that can be incorporated into a manhole area without modification, for replacing foul odors expelled from the manhole with either no scent or a pleasant scent.

### SUMMARY OF THE INVENTION

Disclosed is a device that is placed beneath a manhole cover of a conventional wastewater sewer manhole. The device employs a basket supporting a housing for directing odor laden air across an admixture containing essential oils and a surfactant. The housing has side spacing of wall members within the device is arranged to cause directional flow of the air expelled from the sewer so as to maximize contact with the admixture. The admixture of essential oils and surfactant adsorbs odors by working through an exchange process and releasing a fragrance, thereby exhausting a pleasantly surprising scent from the housing. The housing includes an overflow drain should the container be breached with excess condensate or rainwater; the overflow drain directing fluid directly into the sewer so there is no limitation to flow during heavy rains. A drain valve is further attached to the housing for draining the admixture and allowing for ease of replenishment. A lid on the housing is easily removed so that the admixture can be refilled and the contents of the housing checked. Alternatively, a housing containing activated carbon may be used.

An objective of the invention is to disclose a passive venting device cover that is inexpensive to manufacture, inexpensive to maintain, and effectively controls wastewater odors with no moving parts.

Yet another objective of the instant invention is to disclose a manhole venting device having an internal configuration so as to be concealed within the manhole without modification.

Still another objective of the instant invention is to disclose a manhole venting device having an admixture capable of treating wastewater odors by directing odor laden air across an admixture.

Still another objective of the instant invention is to disclose a venting device having an overflow drain capable of moving excess water contained within a basket or housing directly to the wastewater receiver.

Still another objective of the instant invention is to provide a drain to allow simplicity in cleaning of the housing when the admixture used for treating of odors must be exchanged, and allow excess water to pass.

Other objectives and further advantages and benefits associated with this invention will be apparent to those skilled in the art from the description, examples and claims which follow.

### BRIEF DESCRIPTION OF THE DRAWINGS

FIG. 1 is a cross-sectional view of the instant invention placed on a manhole riser;

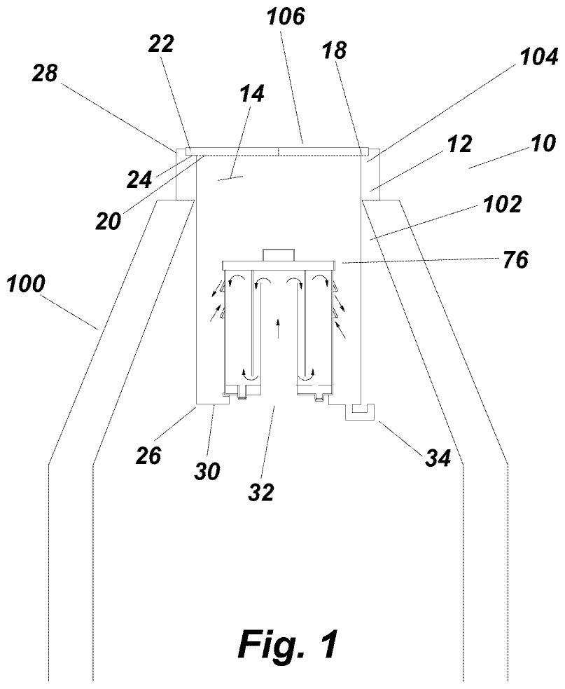

FIG. 2 is an enlarged view thereof;

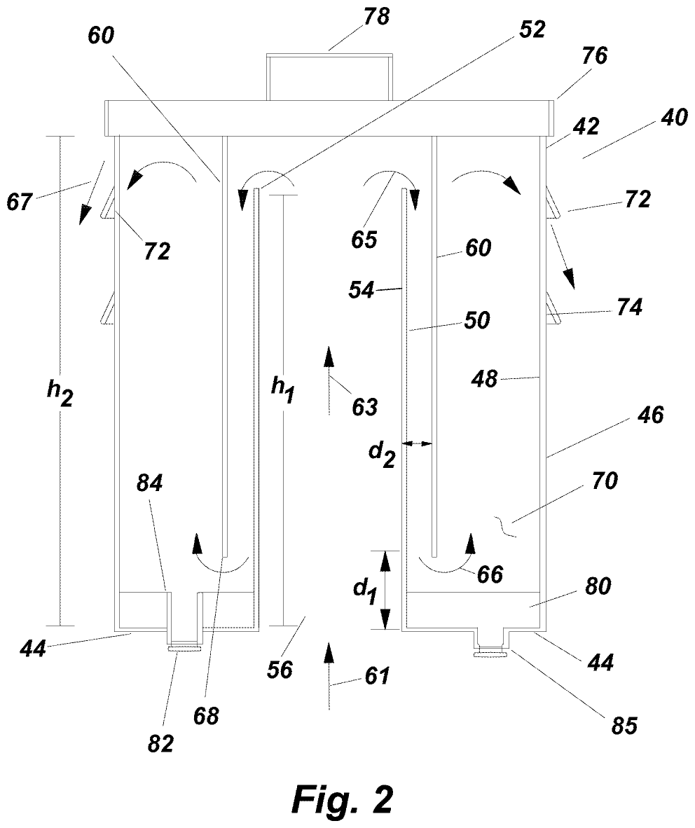

FIG. 3 is a cross-sectional view of a second embodiment placed on a manhole riser; and

FIG. 4 is an enlarged view thereof.

### DETAILED DESCRIPTION OF THE INVENTION

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Now referring to the drawings in general, disclosed is a vent device 10 for use with a manhole riser 100. In a preferred embodiment, the vent device 10 consists of a basket 12 formed from a continuous sidewall 14 forming a circular shape with an upper edge 18 and a lower edge 20, wherein the sidewall 14 is sized to fit within a manhole opening 102. A lip 22 extends outwardly from the upper edge 18. The lip 22 is constructed and arranged to fit a manhole cover support 104. In a preferred embodiment, a gasket 24 is secured to the lower edge 20 of the lip 22 to create a seal between the basket 12 and the manhole cover support 104. A manhole cover 106 is placed over the upper surface 28 of the lip 22, securing the basket 12 to the manhole cover support 104. A bottom wall 30 is secured to the lower edge 26 having a centrally disposed opening 32. A p-trap drain 34 is coupled along t h e lower edge 26 of the bottom wall 30 for draining condensate or rainwater from the basket 12. While the preferred embodiment, the basket 12 and housing 40 can be square, rectangular, or any shape that includes a wall for purposes of air flow directional control, and is deemed within the scope of this invention.

The housing 40 is securable to the bottom wall 30 of the basket 12. Defined by a housing top 42 and a housing bottom 44 with a square shaped continuous outer wall member 46 having an inner surface 48. A circular shaped continuous inner wall member 50 is parallel spaced apart from the outer wall member 46 extending upwardly from the housing bottom 44 to an upper edge 52 set at a predetermined position beneath the housing top 42 further defined as a first height h1. An inner surface 54 of the inner wall member 50 defining an opening 56. A circular shaped continuous baffle wall member 60 is placed between the inner 50 and outer wall member 46. The baffle wall member 60 extending downwardly from the housing top 42 to a predetermined position d1 above the housing bottom 44. The baffle wall member 60 positioned a distance d2 from the inner wall member 50 wherein air flow depicted by directional arrow 61 enters the opening 46 and is directed 63 upward through the inner wall member 50 over upper edge 52 indicated by directional arrow 65 and downward between the inner wall member 50 and baffle wall member 60. The housing opening 56 formed by the housing inner wall 50 is in alignment with the centrally disposed aperture formed by the basket 12. The directed air impacts an admixture 80 as it directed around the lower edge 68 into the expansion chamber 70 for expulsion 67 through vent apertures 72. The vent apertures 72 are large enough to expel air without restriction and preferably include louvers as shown, or the like shape, to prevent fluids from above from entering the housing. The housing may also include a grill 74 to inhibit small animals and reptiles from entering.

A lid 76 is constructed and arranged to fit around the outer perimeter of the outer side wall member 46. The lid 76 having a handle 78 for ease of servicing the housing. Depicted is a substantially square housing having a continuous side walls. However, any shape housing is acceptable with the objective of the baffle wall member 60 for directional flow of air past the admixture 80.

The baffle 60 extends from an inner surface of the lid 76 to a distance d2 spaced above the bottom support surface 44. Air expelled from the sewer is drawn through the opening 56, depicted by arrows 65, and directed downward 65 beneath the baffle edge 68, allowing the air to impact an admixture 80 before leaving the housing through vent apertures 72, depicted by arrows 67.

The bottom support surface 44 holds the admixture 80 which consists of a proprietary formulation of essential oils and a surfactant. The opening 56 causes the air being expelled from the sewer to follow a tortious path, causing a flow to be pushed downward between the inner side wall member 50 and the baffle wall member 60 at an accelerated rate against the admixture 80. Contact with the admixture 80 causes odor laden air to have certain particles adsorbed by the admixture, and a release of a scented fragrance is expelled. The baffle wall member 60 is spaced apart from inner wall member 50 by a predetermined distance d2 calculated to optimize contact time with the admixture 80. After contact the air flow is directed to the chamber 70 where it is then disbursed through the vent apertures 72 formed in the outer walls. In this regard, the scented fragrance would be expelled through the manhole cover 106.

An overflow drain pipe 82 having a distal end 84 is positioned above the surface of the admixture 80 and used to divert excess fluid from within the housing 40. Should fluid in the housing 40 be raised above the distal end 84, the fluid would be in an overflow condition and drain back into the sewer. The overflow drain pipe distal end 84 remains open at all times so as to prevent the admixture 80 from filling up the housing 40 and escaping through the vents 64 due to abnormal events, such as blowing rain or excess condensation. In addition, the overflow outlet may contain a plug with a small orifice to restrict the passage of odor laden air directly into the housing while allowing liquid to drain out. Alternatively, the overflow outlet may be connected to an extension tube with a check valve at the end to allow accumulated liquid to flow out but prevent odorous air from flowing into the housing. Proposed scheduling would recommend the admixture 80 be changed every three months, wherein admixture 80 is discarded or drained by use of a control valve 85.

Refilling of the bottom support surface 44 is performed by removal of the lid 76 with handle 78. When the lid 76 is lifted from the housing 46, replacement admixture 80 is pooled over the bottom support surface 44. Unique to the device is that no further maintenance is required, and there are no moving parts to be serviced within the passive vent device.

The spacing of the baffle wall member 60 permits a large volume of air to be ventilated to be directed past the admixture 80, wherein the spacing between the inner side wall member is critical, both in length and in spacing. The flow will minimize restrictions, but maximize the velocity across the surface of the admixture 80 during the venting process. It should be noted that as the water level in the manhole varies, it displaces or is displaced by an equal volume of air. The venting device 10 treats air being expelled from the wastewater sewer to reduce odors by not only treating those odors that are expelled from the wastewater, but also treating those odors contained within the housing 40. Changing the admixture 80 approximately every three months is suitable in most instances; spoiled admixture 80 can be drained into the wastewater receiver to help control odors within the receiver itself. The illustrated baffle is square shaped; however, a rectangular shape or circular shape may also be used.

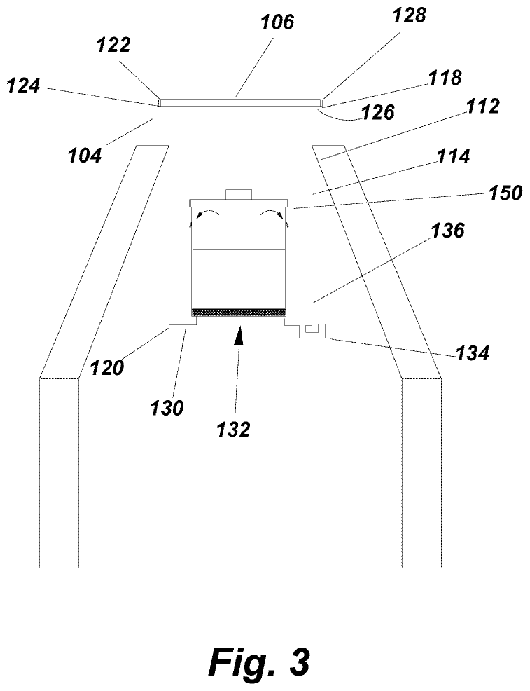

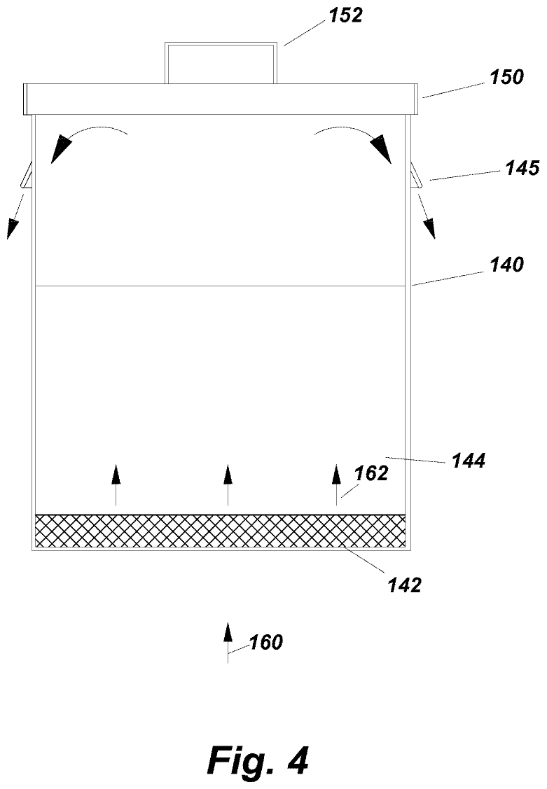

Referring to FIGS. 3 and 4, set forth is a second embodiment having a basket 112 formed from a continuous sidewall 114 forming a circular shape with an upper edge 118 and a lower edge 120, wherein the sidewall 114 is sized to fit within a manhole opening. A lip 122 extends outwardly from the upper edge 118 and is constructed and arranged to fit a manhole cover support 104. In a preferred embodiment, a gasket 124 is secured to the lower surface 126 of the lip 122 to create a seal between the basket 112 and the manhole cover support 104. A manhole cover 106 is placed over the upper surface 128 of the lip 122, securing the basket 112 to the manhole cover support 104.

A bottom wall 130 is secured to the lower edge 120, having a centrally disposed opening 132 and a p-trap drain 134 coupled along an outer edge 136 of the bottom wall 130 for draining condensate or rainwater from the basket 112.

In this embodiment, a housing 140 is securable to the bottom wall 130 of the basket 112. The housing 140 comprises a substantially square structure having a continuous sidewall and a bottom composed of a screen structure 142 for containing activated carbon 144. The continuous sidewalls and a bottom screen directs odorous air directly and uniformly upwards through the activated carbon bed. This prevents short circuiting of odorous air and ensures complete usage of the carbon media. It is recognized that the odor emanating from a receiving well is commonly treated by the use of an activated carbon vent; Applicant's device is used in combination with a manhole installation. Activated carbon consists of a specially treated charcoal capable of and known for adsorbing peculiar gases and odors. Once the activated carbon is exhausted of its ability to adsorb odors, the activated carbon can be disposed of; or more preferably, re-fired, which removes the organics adsorbed and renews the material for additional use. Similar to the admixture embodiment, a lid 150 with a handle 152 allows for ease of servicing the housing 140. Directional arrow 160 illustrates a flow of air through the activated carbon 114 and direction flow 162 through the vents 145.

It will be apparent to those skilled in the art that various changes may be made without departing from the scope of the invention, and the invention is not to be considered limited to what is shown and described in the specification and any drawings/figures included herein. One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims.

Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more elements, possesses those one or more elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

What is claimed is:

1. An odor treatment device for use in combination with a manhole comprising:
a basket formed from a continuous sidewall forming a circular shape with an upper edge and a lower edge wherein said sidewall is sized to fit within a manhole opening, a lip extending outwardly from said upper edge wherein said lip is constructed and arranged to engage a manhole cover support, a bottom wall is secured to said lower edge having a centrally disposed opening and at least one drain coupled along an outer edge of said bottom wall;
a housing securable to said bottom wall of said basket, having a housing top and a housing bottom with a square shaped continuous outer wall member, a circular shaped continuous inner wall member is parallel spaced apart from said outer wall member extending upwardly from said housing bottom to a predetermined position beneath said housing top, and a circular shaped continuous baffle wall member placed between said inner and outer wall member, said baffle wall member extending downwardly from said housing top to a predetermined position above said housing bottom, a housing opening formed by said housing inner wall in alignment with said centrally disposed aperture;
at least one vent aperture formed in said outer wall member; an admixture covering said housing bottom between said inner and said outer wall surface; and a lid releasably secured to said housing and capping said outer wall member;
wherein odor laden air is drawn through the housing opening, over an upper edge of said inner wall, beneath a lower edge of said baffle wall for directional impact with said mixture before expulsion through said vent aperture, whereby said admixture alters the characteristics of the odor laden air.

2. The odor treatment device according to claim 1, wherein said baffle is constructed and arranged to direct the flow of odor laden air in a substantially transverse direction across the surface of said admixture.

3. The odor treatment device according to claim 1, wherein said admixture contains a mixture of essential oils.

4. The odor treatment device according to claim 3, wherein said admixture includes a surfactant.

5. The odor treatment device according to claim 1, wherein said lid is releasably secured to said housing for ease of admixture replenishment.

6. The odor treatment device according to claim 1 wherein said housing bottom includes an overfill port having an upper edge positioned at a predetermined distance above the bottom support surface.

7. The odor treatment device according to claim 1 including a drain positioned along the bottom support surface, wherein said drain is employed for removal of expired admixture from said bottom support surface.

8. The odor treatment device according to claim 1, wherein said housing is constructed and arranged to promote an acceleration of air between said baffle and said inner wall members.

9. The odor treatment device according to claim 1, wherein said baffle is constructed and arrange to cause an acceleration of air across a surface of said admixture.

10. The odor treatment device according to claim 1, wherein said baffle is spaced apart from said outer wall a predetermined distance to decelerate air flow for disbursement through vent apertures formed in said outer walls.

11. The odor treatment device according to claim 1, wherein said inner wall has a first height h1 and said outer wall have a second height h2, wherein said first height h1 of said inner wall is less than said second height h2 of said outer wall.

12. The odor treatment device according to claim 1 including a gasket secured to a lower surface of said basket lip, wherein said gasket seals said basket to a manhole support.
